(19) United States
(12) Patent Application Publication
(10) Pub. No.: US 2008/0290258 A1
(43) Pub. Date: Nov. 27, 2008

(54) AUXILIARY INPUT METHOD FOR ELECTRONIC DEVICE

(75) Inventor: Fu-Jen CHENG, Taipei City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: MITAC TECHNOLOGY CORP., HsinChu (TW)

(21) Appl. No.: 11/967,427

(22) Filed: Dec. 31, 2007

(30) Foreign Application Priority Data
May 25, 2007 (CN) 200710028182.3

(51) Int. Cl. H05B 37/02

(52) U.S. Cl. 250/214 AL

(57) ABSTRACT

An auxiliary input method for an electronic device displays a virtual keyboard input interface optionally on a screen of the electronic device according to an external ambient brightness state of the electronic device, so as to assist the users to input data. The method includes sensing current ambient brightness to obtain an ambient brightness value; comparing the ambient brightness value with a preset brightness value; if the ambient brightness value is lower than the preset brightness value, calculating a duration in which the ambient brightness value is lower than the preset brightness value; comparing the duration with the preset time; if the duration reaches the preset time, displaying the virtual keyboard input interface on the screen of the electronic device, thereby improving the operation convenience of the electronic device.

### CROSS-REFERENCE TO RELATED APPLICATIONS

This non-provisional application claims priority under 35 U.S.C. § 119(a) on Patent Application No(s). 200710028182.3 filed in China on May 25, 2007, the entire contents of which are hereby incorporated by reference.

### BACKGROUND OF THE INVENTION

1. Field of Invention

The present invention relates to an auxiliary input method, and more particularly to an auxiliary input method for an electronic device.

2. Related Art

Along with the development of electronic technology, many miniaturized, multifunctional, and easy-to-operate portable electronic devices such as notebook computers, mobile phones, personal digital assistants (PDA), and global positioning systems (GPS) attract the more attention among the technological electronic products due to the characteristic of “light, thin, and chic”.

As the multimedia function of the portable electronic devices is enhanced, the user begins to read electronic books, browse the internet, or watch movies through the portable electronic device. The user enjoys the convenience brought by the portable electronic devices always and everywhere, but problems come at the same time. When the user operates the portable electronic devices under different ambient brightness, the operation convenience will be affected. That is, when the user operates in an environment with insufficient lights, he/she cannot clearly identify the positions of the input keys on the portable electronic device and the input symbols related to the keys, such that the user cannot conveniently input the data. Although some portable electronic devices today are provided with an auxiliary illumination function to the keys, the above auxiliary illumination function is usually enabled after the user presses the input keys of the electronic device, and will be turned off after a period of inactivity of the input keys of the electronic device. In other words, the above auxiliary illumination function will be enabled no matter whether the light in the user's environment is sufficient or not. Thus, the battery life of the portable electronic devices will be affected after a long period of use. Moreover, if the circuit providing illumination is suddenly damaged, the user cannot use the input keys to input data in the environment with insufficient light.

The current desktop computers may also encounter the same problem. More particularly, the keyboards of most desktop computers are not provided with the auxiliary illumination function. Thus, the convenience in using the electronic devices needs improvements.

### SUMMARY OF THE INVENTION

In view of the above problems, the present invention is directed to an auxiliary input method for an electronic device, which selectively displays a virtual keyboard input interface on a screen of the electronic device according to an external ambient brightness state of the electronic device, so as to assist the user to input data, thereby improving the operation convenience of the electronic device.

The auxiliary input method for an electronic device according to the present invention includes the following steps. First, the current ambient brightness is sensed to obtain an ambient brightness value. The ambient brightness value is compared with a preset brightness value. If the ambient brightness value is lower than the preset brightness value, a duration in which the ambient brightness value is lower than the preset brightness value is calculated. The duration is compared with the preset time. If the duration reaches the preset time, the virtual keyboard input interface is displayed on the screen of the electronic device.

The auxiliary input method for an electronic device has at least the following effects.

1. When the ambient light is not sufficient, the user can continue inputting data by the use of the virtual keyboard input interface displayed on the screen of the electronic device, thereby improving the operation convenience of the electronic device.

2. Auxiliary illumination is not required for illuminating the input keys of the electronic device, thus reducing the electricity consumption of the electronic device, and further extending the battery life.

### BRIEF DESCRIPTION OF THE DRAWINGS

The present invention will become more fully understood from the detailed description given herein below for illustration only, and thus are not limitative of the present invention, and wherein:

FIG. 1 is a flow chart of an embodiment of the present invention; and

FIG. 2 is a schematic appearance view of the embodiment of the present invention.

### DETAILED DESCRIPTION OF THE INVENTION

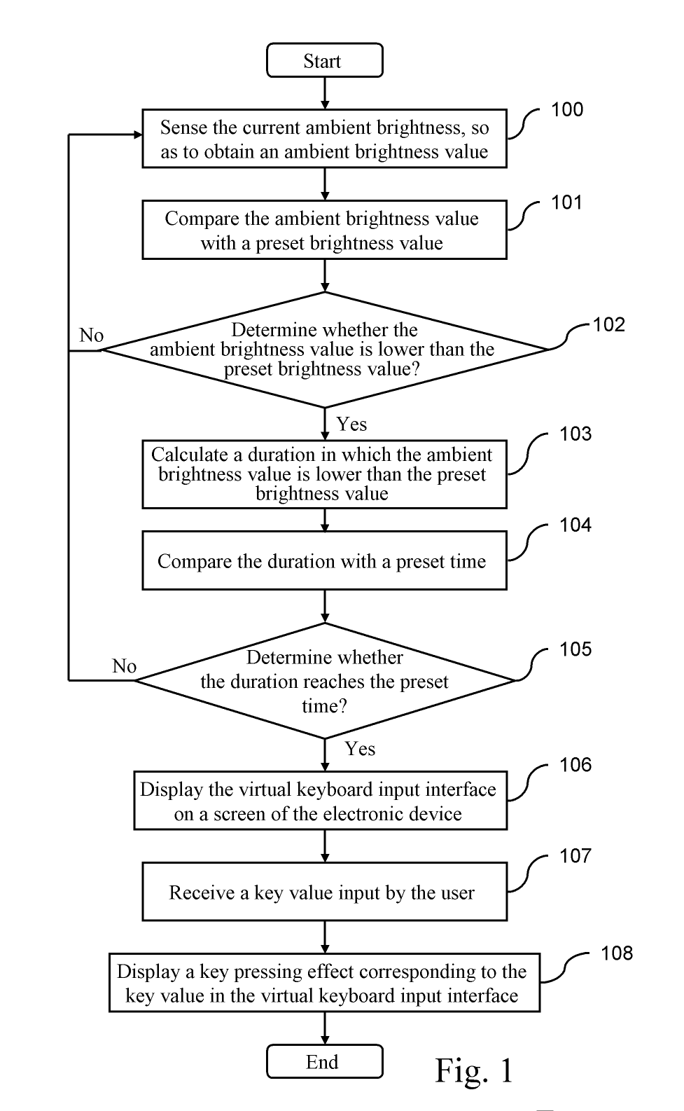

FIG. 1 is a flow chart of an embodiment of the present invention. As shown in FIG. 1, the auxiliary input method for an electronic device of the present invention includes the following steps.

Firstly, when the electronic device (e.g., a desktop computer) is operated, a light sensor circuit is used to sense the current ambient brightness so as to obtain an ambient brightness value (Step 100). The ambient brightness value is, for example, a digital data or voltage level signal. A light sensor in the light sensor circuit is, for example, a photo diode or a cadmium sulfide (Cds) photosensitive resistor.

Then, a terminate and stay resident (TSR) program in the electronic device compares the ambient brightness value with a preset brightness value (Step 101). The preset brightness value (e.g., a range or a single brightness value in 10 LUX to 2000 LUX) may be stored in a memory of the electronic device in advance, and can be adjusted by the user.

The TSR program determines whether the ambient brightness value is lower than the preset brightness value according to the comparison result (Step 102). When the ambient brightness value is lower than the preset brightness value, the duration in which the ambient brightness value is lower than the preset brightness value is calculated through a timer circuit or a timer program (Step 103). If the ambient brightness value is higher than or equal to the preset brightness value, return to the Step 100 to continue to sense the current ambient brightness.

Then, the TSR program compares the duration with the preset time (Step 104). The preset time (e.g., a range or a single time in 10 secs to 60 secs) is stored in a memory of the electronic device, and can be adjusted by the user. The preset time is used to exclude the situation that the ambient light is temporarily insufficient.

The TSR program determines whether the duration reaches the preset time according to the comparison result (Step 105). If yes, the TSR program displays the virtual keyboard input interface on the screen of the electronic device (Step 106). The virtual keyboard input interface is a graphical user interface built according to the arrangement positions, marking symbols, marking numerals, or marking pinyin codes of the input keys on the electronic device. If the duration does not reach the preset time, return to the step 100 to continue to sense the current ambient brightness.

Then, the user operates the input keys on the electronic device according to the virtual keyboard input interface displayed on the screen. The TSR program receives the key values input by the user (Step 107) and displays the key pressing effect corresponding to the key value in the virtual keyboard input interface (Step 108). In this manner, without using auxiliary illumination, the user can still confirm the position of the currently pressed input key through the key pressing effect displayed in the virtual keyboard input interface. Moreover, persons skilled in the art may easily understand that Step 103 through Step 105 may be omitted.

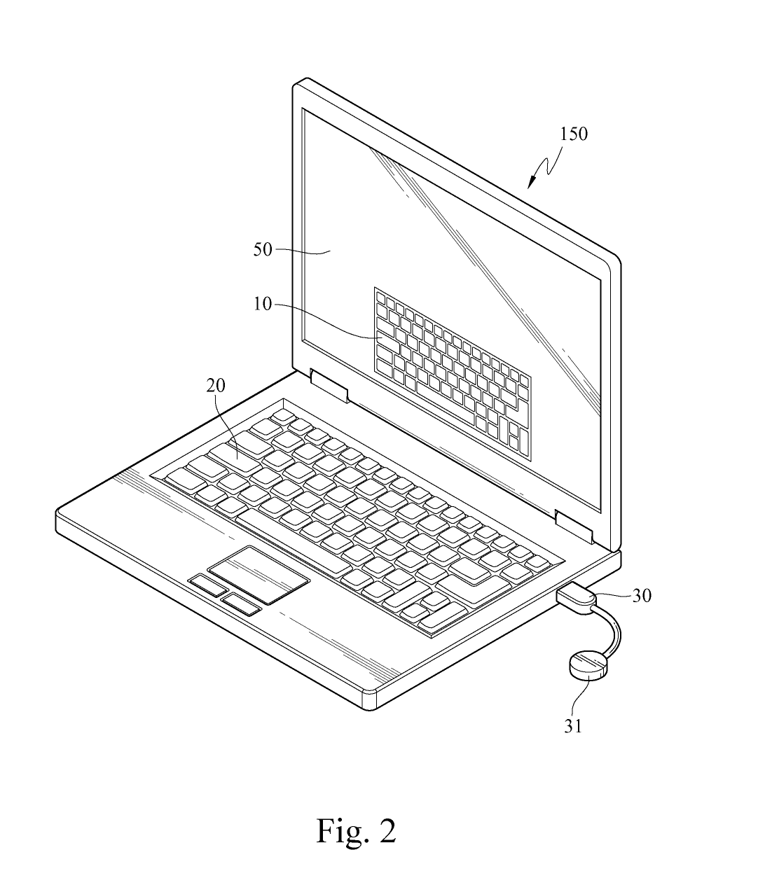

FIG. 2 is a schematic appearance view of the embodiment of the present invention. As shown in FIG. 2, the electronic device is, for example, a notebook computer 150, which includes a screen 50 and a keyboard 20. One light sensor 31 is connected to the side edge of the notebook computer 150, and the light sensor 31 is connected to the notebook computer 150 through a universal serial bus interface 30.

First, when the notebook computer 150 is operated, the light sensor 31 is used to sense the current ambient brightness so as to obtain an ambient brightness value. Then, a TSR program in the notebook computer 150 compares the ambient brightness value with a preset brightness value. When the ambient brightness value is lower than the preset brightness value, the duration in which the ambient brightness value is lower than the preset brightness value is calculated through a timer circuit (not shown) or a timer program (not shown). When the duration reaches the preset time, the TSR program displays the virtual keyboard input surface 10 on the screen 50 of the notebook computer 150. In this manner, when the ambient light is insufficient, the user can also continue inputting the data by the use of the virtual keyboard input interface 10 displayed on the screen 50 of notebook computer 150. Moreover, the light sensor 31 in this embodiment is externally connected to the notebook computer 150. Persons skilled in the art may easily understand that the light sensor 31 may also be embedded into the body of the notebook computer 150.

In view of the above, the auxiliary input method for an electronic device of the present invention enables the user to continue inputting the data by the use of the virtual keyboard input interface displayed on the screen of notebook computer when the ambient light is insufficient, thereby improving the operation convenience of the electronic device. And, the auxiliary illumination is not required for illuminating the input keys of the electronic device, thereby reducing the electricity consumption of the electronic device, and further extending the battery life of portable electronic device.

What is claimed is:

1. An auxiliary input method for an electronic device, comprising:
(a) sensing a current ambient brightness, so as to obtain an ambient brightness value;
(b) comparing the ambient brightness value with a preset brightness value; and
(c) if the ambient brightness value is lower than the preset brightness value, displaying a virtual keyboard input interface on a screen of the electronic device.

2. The auxiliary input method for an electronic device as claimed in claim 1, wherein the step (c) further comprises:
(c1) calculating a duration in which the ambient brightness value is lower than the preset brightness value;
(c2) comparing the duration with a preset time; and
(c3) if the duration reaches the preset time, displaying the virtual keyboard input interface on a screen of the electronic device.

3. The auxiliary input method for an electronic device as claimed in claim 2, after the step (c3), further comprising:
receiving a key value input by a user; and
displaying a key pressing effect corresponding to the key value in the virtual keyboard input interface.

4. The auxiliary input method for an electronic device as claimed in claim 2, wherein if the duration does not reach to the preset time, return to the step (a).

5. The auxiliary input method for an electronic device as claimed in claim 1, wherein if the ambient brightness value is higher than or equal to the preset brightness value, return to the step (a).
